(19) United States
(12) Patent Application Publication
(10) Pub. No.: US 2024/0340785 A1
(43) Pub. Date: Oct. 10, 2024

(54) CELL RE-SELECTION PROCEDURE FOR MULTI-PANEL USER EQUIPMENT WITH NETWORK SLICING

(71) Applicant: Nokia Technologies Oy, Espoo (FI)

(72) Inventors: Halit Murat GÜRSU, Munich (DE); György Tamás WOLFNER, Budapest (HU); Ahmad AWADA, Munich (DE); Ömer BULAKCI, Munich (DE)

(21) Appl. No.: 18/294,779

(22) PCT Filed: Jul. 6, 2022
(86) PCT No.: PCT/EP2022/068733

§ 371 Date: Feb. 2, 2024

(30) Foreign Application Priority Data
Aug. 6, 2021 (FI) 20215840

(51) Int. Cl. H04W 48/20; H04B 7/08; H04W 36/00; H04W 48/18

(52) U.S. Cl. CPC H04W 48/20; H04B 7/088; H04W 36/0058; H04W 48/18

(57) ABSTRACT

The present disclosure relates to a technique for performing a cell re-selection procedure for a multi-panel user equipment (MPUE) in a wireless communication network that supports network slicing. More specifically, the proposed technique involves considering a spatial separation or, in other words, orthogonality between cells that support the network slice(s) of the mobile MPUE and other neighbouring cells. The mobile MPUE camps/reselects a cell X that supports its network slices only if the spatial separation between the cell X and other neighbouring cells is deemed to be high enough by the MPUE based on parameters received from a serving network node. The parameters may be reported to the MPUE by using a dedicated or broadcast signalling. By so doing, it is possible to provide the slice-based cell re-selection procedure for the mobile MPUE, which may be effectively (in terms of inter-cell interference suppression) used in the intra-frequency scenario.

### TECHNICAL FIELD

The present disclosure relates generally to the field of wireless communications and, in particular, to a technique for performing a cell re-selection procedure for a multi-panel user equipment (MPUE) in a wireless communication network that supports network slicing.

### BACKGROUND

The next generation of wireless communication networks (e.g., fifth-generation (5G) networks) is expected to support different network slices. Each network slice can be considered as an independent network partition optimized to support the performance requirements of a certain application or service category. For example, a wireless communication network may comprise a first network slice designed to support an “Enhanced Mobile Broadband (eMBB)” service category, a second network slice designed to support an “Ultra-reliable and Low Latency Communications (ULLC)” service category, and a third network slice designed to support a “Internet of Things (IoT)” application category. It should be also noted that a particular type of network slice may be deployed multiple times (i.e. have multiple instances) within the same wireless communication network. For example, a network operator may deploy multiple IoT slice instances to support multiple IoT customers, such as utility companies, entertainment companies, etc. To support several service categories, it is required for the same UE to connect to multiple network slices. One of the main issues associated with network slicing is that some of enterprise/industrial scenarios have a requirement for service continuity in case a network slice does not exist in neighbouring cells and a UE moves to those neighbouring cells. To provide such service continuity, the UE should not have an interruption in any of ongoing Protocol Data Unit (PDU) sessions. Therefore, when moving among the neighbouring cells, the UE may rely on a cell re-selection procedure, as defined by 3rd Generation Partnership Project (3GPP) (see, for example, 3GPP TS 38.304). The purpose of the cell re-selection procedure is to ensure that the UE is always camped on a suitable cell. The network itself can influence this procedure by adjusting the broadcast information of individual cells in different System Information Blocks (SIBs). These SIBs comprise several configuration parameters that the UE can use to evaluate the communication quality of a currently camped-on (or, in other words, currently selected) cell and neighbouring cells to switch the camped-on cell as the UE moves across borders of different cells.

However, the existing cell re-selection procedures are mainly slice agnostic, i.e. the UE does not consider the slice support of the neighbouring cells while evaluating the neighbour cells. Moreover, the existing cell re-selection procedures do not consider MPUE aspects and do not leverage the spatial separation (or, in other words, orthogonality) between the neighbouring cells when selecting the most suitable cells for MPUEs.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that enables a slice-based cell re-selection procedure for a MPUE in a wireless communication network.

The objective above is achieved by the features of the independent claims in the appended claims. Further embodiments and examples are apparent from the dependent claims, the detailed description and the accompanying drawings.

According to a first aspect, a mobile UE in a wireless communication network supporting a plurality of network slices is provided. The mobile UE comprises at least two antenna panels, a processor coupled to the at least two antenna panels, and a memory coupled to the processor and storing processor-executable instructions. Each of the at least two antenna panels has a different angular coverage. When executed, the processor-executable instructions cause the processor to operate as follows. At first, the processor obtains at least one candidate cell for a cell re-selection procedure. Each of the at least one candidate cell has a rank. Then, the processor determines whether a best-ranked candidate cell of the at least one candidate cell supports a network slice of interest of the plurality of network slices. If the best-ranked candidate cell does not support the network slice of interest, the processor determines whether the at least one candidate cell comprises at least one orthogonal cell by performing one or more communication quality measurements on each of the at least one candidate cell using one or more of the at least two antenna panels. Next, if the at least one candidate cell comprises the at least one orthogonal cell, the processor determines whether the at least one orthogonal cell comprises an orthogonal cell that supports the network slice of interest. If the at least one orthogonal cell comprises the orthogonal cell that supports the network slice of interest, the processor selects the orthogonal cell for the cell re-selection procedure. With such configuration, the UE according to the first aspect may perform the slice-based cell re-selection procedure, while considering the spatial separation or orthogonality between the candidate cells based on their communication qualities.

In one example embodiment of the first aspect, the at least one candidate cell comprises a set of candidate cells. In this embodiment, the processor is configured to determine that a candidate cell of the set of candidate cells is an orthogonal cell if the candidate cell, when measured using said one or more of the at least two antenna panels, has a communication quality at least a threshold higher than a communication quality of each other candidate cell of the set of candidate cells. By using such a threshold, it is possible to perform the orthogonality check for each candidate cell more efficiently. For example, this may allow the UE to connect to a neighbouring cell X supporting a desired network slice even if it is weaker than another neighbouring cell measured by an antenna panel selected for the neighbouring cell X but way stronger than any other cell measured by using the same antenna panel.

In one example embodiment of the first aspect, the processor is configured to select the same antenna panel of the at least two antenna panels to perform the communication quality measurements on each candidate cell of the set of candidate cells. This embodiment may be useful when it is desired to avoid using multiple antenna panels for the communication quality measurements.

In another example embodiment of the first aspect, the processor is configured to select two or more antenna panels of the at least two antenna panels to perform the communication quality measurements on each candidate cell of the set of candidate cells. This embodiment may be useful when it is desired to use multiple antenna panels for the communication quality measurements.

In one example embodiment of the first aspect, the processor is configured, for each candidate cell of the set of candidate cells, to select, from the at least two antenna panels, an antenna panel which receives a stronger and/or higher-quality beam from the candidate cell. In this embodiment, the processor is configured to perform the communication quality measurements on the candidate cell by using the selected antenna panel. By so doing, the UE according to the first aspect may select the most suitable antenna panel for the quality communication measurements.

In another example embodiment of the first aspect, the processor is configured, for each candidate cell of the set of candidate cells, to select, from the at least two antenna panels, an antenna panel which receives a higher number of beams from the candidate cell. In this embodiment, the processor is configured to perform the communication quality measurements on the candidate cell using the selected antenna panel. By so doing, the UE according to the first aspect may select the most suitable antenna panel for the quality communication measurements.

In one example embodiment of the first aspect, the processor is further configured, if the best-ranked candidate cell supports the network slice of interest, to select the best-ranked candidate cell for the cell re-selection procedure. This may provide more technical feasibility for the UE according to the first aspect to select the cell that supports the network slice of interest.

In one example embodiment of the first aspect, the processor is further configured, if the at least one candidate cell does not comprise the at least one orthogonal cell, to select the best-ranked candidate cell for the cell re-selection procedure. This may allow the UE according to the first aspect to select the cell with the best communication quality (i.e. the best rank) if the slice-based cell re-selection procedure cannot be achieved.

In one example embodiment of the first aspect, the processor is further configured, if the at least one orthogonal cell comprises a set of orthogonal cells, to operate as follows. At first, the processor measures a communication quality for each orthogonal cell of the set of orthogonal cells by using said one or more of the at least two antenna panels. Then, the processor ranks the set of orthogonal cells based on the communication qualities. Next, the processor determines whether a best-ranked orthogonal cell of the ranked set of orthogonal cells supports the network slice of interest. If the best-ranked orthogonal cell of the ranked set of orthogonal cells supports the network slice of interest, the processor selects the best-ranked orthogonal cell for the cell re-selection procedure. This may provide more technical feasibility for the UE according to the first aspect to select the cell that supports the network slice of interest.

In one example embodiment of the first aspect, the processor is further configured, if the best-ranked orthogonal cell does not support the network slice of interest, to determine whether the ranked set of orthogonal cells comprises a lower-ranked orthogonal cell that supports the network slice of interest. If the ranked set of orthogonal cells comprises the lower-ranked orthogonal cell that supports the network slice of interest, the processor is further configured to select the lower-ranked orthogonal cell for the cell re-selection procedure. This may provide more technical feasibility for the UE according to the first aspect to select the cell that supports the network slice of interest.

In one example embodiment of the first aspect, the processor is further configured, if the ranked set of orthogonal cells does not comprise the lower-ranked orthogonal cell that supports the network slice of interest, to select the best-ranked candidate cell for the cell re-selection procedure. This may allow the UE according to the first aspect to select the cell with the best communication quality (i.e. the best rank) if the slice-based cell re-selection procedure cannot be achieved.

In one example embodiment of the first aspect, the processor is further configured to generate a UE message comprising a configuration parameter of the mobile UE and an indication of the network slice of interest and use one or more of the at least two antenna panels to transmit the UE message to a network node currently serving the mobile UE in the wireless communication network. In this embodiment, the processor is further configured to receive, by using the same antenna panel(s), the threshold or at least one parameter for determining the threshold from the network node. By so doing, the UE according to the first aspect may receive the most relevant threshold used in the slice-based cell re-selection procedure.

In one example embodiment of the first aspect, the configuration parameter comprises at least one of: a number of the at least two antenna panels, a number of antenna elements in each of the at least two antenna panels, a gain of each antenna element in each of the at least two antenna panels, and a hardware specification of the mobile UE. By using this configuration parameter, it is possible to obtain the most accurate threshold for the mobile UE according to the first aspect.

In one example embodiment of the first aspect, the processor is further configured to receive the threshold value or the at least one parameter for determining the threshold via at least one of a broadcast signaling and a dedicated signaling from the network node. By so doing, it is possible to inform the UE according to the first aspect about the most relevant threshold values more efficiently.

In one example embodiment of the first aspect, the at least one candidate cell comprises a set of intra-frequency cells. This means that the mobile UE according to the first aspect may perform the slice-based cell re-selection procedure even in case of an intra-frequency multi-cell scenario without causing any inter-cell interference.

According to a second aspect, a network node in a wireless communication network supporting a plurality of network slices is provided. The network node comprises a transceiver, a processor coupled to the transceiver, and a memory coupled to the processor and storing processor-executable instructions. When executed, the processor-executable instructions cause the processor to operate as follows. At first, the processor defines a threshold or at least one parameter for determining the threshold for a multi-panel mobile UE in the wireless communication network. The threshold is to be used by the mobile UE to find at least one orthogonal cell in a set of candidate cells used for a cell re-selection procedure. A candidate cell of the set of candidate cells is an orthogonal cell if the candidate cell, when measured using one or more antenna panels of the mobile UE, has a communication quality at least the threshold higher than a communication quality of each other candidate cell of the set of candidate cells. The processor then uses the transceiver to transmit the threshold or the at least one parameter for determining the threshold to the mobile UE. By so doing, the network node according to the second aspect may facilitate the slice-based cell re-selection procedure performed by the mobile UE. In other words, the network node according to the second aspect may assist the mobile UE to select the best cell that supports the network slice of interest.

In one example embodiment of the second aspect, the processor is configured to receive, by using the transceiver, a UE message from the mobile UE. The UE message comprises a configuration parameter of the mobile UE and an indication of a network of interest among the plurality of network slices. In this embodiment, the processor is configured to define the threshold or the at least one parameter for determining the threshold based on the UE message. By using such a UE message, the network node according to the second aspect may define the most relevant threshold or parameter(s) for its determination.

In one example embodiment of the second aspect, the configuration parameter comprises at least one of: a number of the antenna panels in the mobile UE, a number of antenna elements in each of the antenna panels, a gain of each antenna element in each of the antenna panels, and a hardware specification of the mobile UE. By using this configuration parameter, it is possible to obtain the most accurate threshold for the mobile UE.

In one example embodiment of the second aspect, the processor is configured to transmit the threshold or the at least one parameter for determining the threshold to the mobile UE via at least one of a broadcast signaling and a dedicated signaling. By so doing, the network node according to the second aspect may efficiently inform the mobile UE about the threshold.

According to a third aspect, a method for operating a mobile UE in a wireless communication network supporting a plurality of network slices is provided. According to the method, the mobile UE comprises at least two antenna panels each having a different angular coverage. The method starts with the step of obtaining at least one candidate cell for a cell re-selection procedure. Each of the at least one candidate cell has a rank. Then, the method proceeds to the step of determining whether a best-ranked candidate cell of the at least one candidate cell supports a network slice of interest of the plurality of network slices. If the best-ranked candidate cell does not support the network slice of interest, the method goes on to the step of determining whether the at least one candidate cell comprises at least one orthogonal cell by performing one or more communication quality measurements on each of the at least one candidate cell using one or more of the at least two antenna panels. After that, if the at least one candidate cell comprises the at least one orthogonal cell, the method proceeds to the step of determining whether the at least one orthogonal cell comprises an orthogonal cell that supports the network slice of interest. If the at least one orthogonal cell comprises the orthogonal cell that supports the network slice of interest, the method goes on to the step of selecting the orthogonal cell for the cell re-selection procedure. By so doing, it is possible to provide the slice-based cell re-selection procedure for multi-panel UEs, while considering the spatial separation or orthogonality between the cells based on their communication qualities.

According to a fourth aspect, a method for operating a network node in a wireless communication network supporting a plurality of network slices is provided. The method starts with the step of defining a threshold or at least one parameter for determining the threshold for a multi-panel mobile UE in the wireless communication network. The threshold is to be used by the mobile UE to find at least one orthogonal cell in a set of candidate cells used for a cell re-selection procedure. A candidate cell of the set of candidate cells is an orthogonal cell if the candidate cell, when measured using one or more antenna panels of the mobile UE, has a communication quality at least the threshold higher than a communication quality of each other candidate cell of the set of candidate cells. After that, the method proceeds to the step of transmitting the threshold or the at least one parameter for determining the threshold to the mobile UE. By so doing, it is possible to facilitate the slice-based cell re-selection procedure performed by the mobile UE. In other words, by using the method according to the fourth aspect, it is possible to assist the mobile UE to select the best cell that supports the network slice of interest.

According to a fifth aspect, a computer program product is provided. The computer program product comprises a computer-readable storage medium that stores a computer code. Being executed by at least one processor, the computer code causes the at least one processor to perform the method according to the third aspect. By using such a computer program product, it is possible to simplify the implementation of the method according to the third aspect in any mobile UE, like the mobile UE according to the first aspect.

According to a sixth aspect, a computer program product is provided. The computer program product comprises a computer-readable storage medium that stores a computer code. Being executed by at least one processor, the computer code causes the at least one processor to perform the method according to the fourth aspect. By using such a computer program product, it is possible to simplify the implementation of the method according to the fourth aspect in any network node, like the network node according to the second aspect.

According to a seventh aspect, a mobile UE in a wireless communication network supporting a plurality of network slices is provided. The mobile UE comprises at least two transceiving means each having a different angular coverage. The mobile UE further comprises a means for obtaining at least one candidate cell for a cell re-selection procedure. Each of the at least one candidate cell has a rank. The mobile UE further comprises a means for determining whether a best-ranked candidate cell of the at least one candidate cell supports a network slice of interest of the plurality of network slices. If the best-ranked candidate cell does not support the network slice of interest, the mobile UE further comprises a means for determining whether the at least one candidate cell comprises at least one orthogonal cell by performing one or more communication quality measurements on each of the at least one candidate cell using one or more of the at least two antenna panels. If the at least one candidate cell comprises the at least one orthogonal cell, the mobile UE further comprises a means for determining whether the at least one orthogonal cell comprises an orthogonal cell that supports the network slice of interest. If the at least one orthogonal cell comprises the orthogonal cell that supports the network slice of interest, the mobile UE further comprises a means for selecting the orthogonal cell for the cell selection procedure. With such configuration, the UE according to the seventh aspect may perform the slice-based cell re-selection procedure, while considering the spatial separation or orthogonality between the cells based on their communication qualities.

According to an eighth aspect, a network node in a wireless communication network supporting a plurality of network slices is provided. The network node comprises a means for defining a threshold or at least one parameter for determining the threshold for a multi-panel mobile UE in the wireless communication network. The threshold is to be used by the mobile UE to find at least one orthogonal cell in a set of candidate cells used for a cell re-selection procedure. A candidate cell of the set of candidate cells is an orthogonal cell if the candidate cell, when measured using one or more antenna panels of the mobile UE, has a communication quality at least the threshold higher than a communication quality of each other candidate cell of the set of candidate cells. The network node further comprises a means for transmitting the threshold or the at least one parameter for determining the threshold to the mobile UE. By so doing, the network node according to the eighth aspect may facilitate the slice-based cell re-selection procedure performed by the mobile UE. In other words, the network node according to the eighth aspect may assist the mobile UE to select the best cell that supports the network slice of interest.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 schematically shows a structure of typical Single-Network Slice Selection Assistance Information (S-NSSAI) in accordance with the prior art;

FIG. 2 schematically explains an inter-cell interference issue in an intra-frequency scenario when a mobile UE has an omnidirectional antenna;

FIG. 3 schematically explains how the inter-cell interference issue may be resolved in the intra-frequency scenario by using a proper antenna panel orientation in a multi-panel UE (MPUE);

FIG. 4 schematically explains how an improper antenna panel orientation in the mobile MPUE shown in FIG. 3 may still cause the inter-cell interference issue in the intra-frequency scenario;

FIG. 5 shows a general block-scheme of a mobile MPUE in accordance with one example embodiment;

FIG. 6 shows a flowchart of a method for operating the mobile MPUE shown in FIG. 4 in accordance with a first example embodiment;

FIG. 7 shows a flowchart of a method for operating the mobile MPUE shown in FIG. 4 in accordance with a second example embodiment;

FIG. 8 shows a general block-scheme of a network node in accordance with one example embodiment;

FIG. 9 shows a flowchart of a method for operating the network node shown in FIG. 7 in accordance with one example embodiment; and

FIG. 10 shows an interaction diagram that explains the interaction between the mobile MPUE shown in FIG. 5 and network nodes serving neighbouring and selected (camped-on) cells in accordance with one example embodiment.

### DETAILED DESCRIPTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and methods disclosed herein can be implemented in practice by using any numbers of the embodiments provided herein. Furthermore, it should be understood that any embodiment of the present disclosure can be implemented using one or more of the elements presented in the appended claims.

Unless otherwise stated, any embodiment recited herein as “example embodiment” should not be construed as preferable or having an advantage over other embodiments.

Although the numerative terminology, such as “first”, “second”, etc., may be used herein to describe various embodiments, it should be understood that the embodiments should not be limited by this numerative terminology. This numerative terminology is used herein only to distinguish one embodiment from another embodiment. Thus, a first embodiment discussed below could be called a second embodiment and vice versa, without departing from the teachings of the present disclosure.

According to the example embodiments disclosed herein, a mobile user equipment (UE) may refer to a mobile device that is configured to perform wireless communications by using two or more differently oriented antenna panels (i.e., one or more antenna panels each with a different angular coverage). It should be noted that such a mobile UE is also referred to as a multi-panel UE (MPUE). Each antenna panel may be also referred to as an antenna array or antenna module comprising a plurality of closely spaced antenna elements which are all oriented in a certain direction. One non-restrictive example of such antenna elements includes patch antennas. The mobile UE may have an individual antenna panel on each or some of its sides. For example, there may be only a front antenna panel and a rear antenna panel installed in the mobile UE. The exact arrangement and number of the antenna panels may depend on a certain type of the mobile UE. For example, the mobile UE may be implemented as a mobile station, a mobile terminal, a mobile subscriber unit, a mobile phone, a cellular phone, a smart phone, a cordless phone, a personal digital assistant (PDA), a wireless communication device, a laptop computer, a tablet computer, a gaming device, a netbook, a smartbook, an ultrabook, a medical mobile device or equipment, a biometric sensor, a wearable device (e.g., a smart watch, smart glasses, a smart wrist band, etc.), an entertainment device (e.g., an audio player, a video player, etc.), a vehicular component or sensor (e.g., a driver-assistance system), a smart meter/sensor, an unmanned vehicle (e.g., an industrial robot, a quadcopter, etc.) and its component (e.g., a self-driving car computer), industrial manufacturing equipment, a global positioning system (GPS) device, an Internet-of-Things (IoT) device, an Industrial IoT (IIoT) device, a machine-type communication (MTC) device, a group of Massive IoT (MIoT) or Massive MTC (mMTC) devices/sensors, or any other suitable mobile device configured to support wireless communications. In some embodiments, the mobile UE may refer to at least two collocated and inter-connected UEs thus defined.

As used in the example embodiments disclosed herein, a network node may relate to a fixed point of communication for the mobile UE in a particular wireless communication network. The network node is used to connect the mobile UE to a Data Network (DN) through a Core Network (CN) and may be referred to as a base transceiver station (BTS) in terms of the 2G communication technology, a NodeB in terms of the 3G communication technology, an evolved NodeB (eNodeB) in terms of the 4G communication technology, and a gNB in terms of the 5G New Radio (NR) communication technology. The network node may serve different cells, such as a macrocell, a microcell, a picocell, a femtocell, and/or other types of cells. The macrocell may cover a relatively large geographic area (for example, at least several kilometers in radius). The microcell may cover a geographic area less than two kilometers in radius, for example. The picocell may cover a relatively small geographic area, such, for example, as offices, shopping malls, train stations, stock exchanges, etc. The femtocell may cover an even smaller geographic area (for example, a home). Correspondingly, the network node serving the macrocell may be referred to as a macro node, the network node serving the microcell may be referred to as a micro node, and so on.

According to the example embodiments disclosed herein, a wireless communication network, in which the mobile UE and the network node communicate with each other, may refer to a cellular or mobile network, a Wireless Local Area Network (WLAN), a Wireless Personal Area Networks (WPAN), a Wireless Wide Area Network (WWAN), a satellite communication (SATCOM) system, or any other type of wireless communication networks. Each of these types of wireless communication networks supports wireless communications according to one or more communication protocol standards. For example, the cellular network may operate according to the Global System for Mobile Communications (GSM) standard, the Code-Division Multiple Access (CDMA) standard, the Wide-Band Code-Division Multiple Access (WCDM) standard, the Time-Division Multiple Access (TDMA) standard, or any other communication protocol standard, the WLAN may operate according to one or more versions of the IEEE 802.11 standards, the WPAN may operate according to the Infrared Data Association (IrDA), Wireless USB, Bluetooth, or ZigBee standard, and the WWAN may operate according to the Worldwide Interoperability for Microwave Access (WiMAX) standard.

As used in the example embodiments disclosed herein, network slicing may be considered as a key 5G feature to support different services using the same underlying mobile network infrastructure. Network slices may differ either in their service requirements like URLLC and eMBB, or the tenant that provides those services. Each network slice is uniquely identified via Single-Network Slice Selection Assistance Information (S-NSSAI). Current 3GPP specifications allow a mobile UE to be simultaneously connected and served by at most eight S-NSSAIs. On other hand, each cell may support tens or even hundreds of S-NSSAIs, e.g., in the current 3GPP specifications a tracking area (TA) may have a support up to 1024 network slices.

It should be also noted that a list of TAs defines a registration area (RA) of a mobile UE, which supports the same network slices from a UE perspective, i.e., allowed NSSAIs. When the mobile UE registers to a certain wireless communication network, it may indicate the network slices to which it may need access (S-NSSAIs of interest). The CN analyses a mobile UE profile and subscription data in the DN to verify a list of network slices the mobile UE can really have access to. As a result, the CN sends the list of “allowed network slices” to the mobile UE, i.e., the allowed NSSAIs. The list of allowed network slices could be different or only a subset of the requested network slices from a UE request in the registration process. The reason could be that the mobile UE does not have access to a specific network slice, or the network slice is not supported in a current location (i.e., TA) in which a registration request was initiated. Thus, the RA comprises the list of TAs in which all the allowed network slices of the mobile UE are supported. The CN knows the current TA of the mobile UE from the registration request and knows the slice support of the neighbouring TAs. By using this information, the CN may configure the list of TAs for the mobile UE, in which the slice support is homogenous for the requesting mobile UE. Once the mobile UE goes outside of the TAs in the RA, it needs to perform an RA update, and the CN re-evaluates the UE requested network slices to configure a new RA.

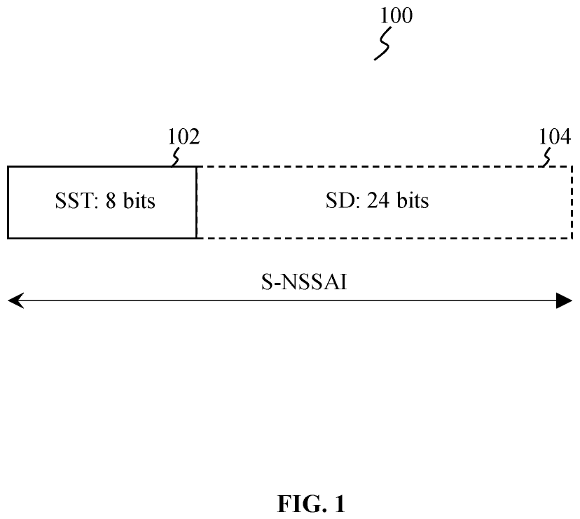

FIG. 1 schematically shows a structure 100 of typical S-NSSAI in accordance with the prior art. The structure 100 of the typical S-NSSAI comprises both a Slice Service Type (SST) field 102 and a Slice Differentiator (SD) field 104 with a total length of 32 bits. It should be noted that the structure 100 of the typical S-NSSAI may include only the SST field 102, in which case the length of the S-NSSAI is 8 bits only. The SST field 102 may have standardized and non-standardized values. Values from 0 to 127 belong to a standardized SST range. For example, the SST value of 1 may indicate that a desired network slice is suitable for handling 5G eMBB services, the SST value of 2 may indicate that the desired network slice is suitable for handling URLLC services, etc. The SD field 104 is operator-defined only.

Currently, it is agreed to provide cell re-selection priorities to guide a Radio Resource Control (RRC)-idle or RRC-inactive UE to a cell that supports its allowed S-NSSAIs. It is discussed that this can only be achieved without any interference issue in inter-frequency. This is because the process of not selecting the best cell and searching for another suitable cell in another frequency band would not cause any interference issue. To provide a slice-based cell re-selection procedure, a network node could broadcast, to a mobile UE, information about supported network slices in a current cell and neighbouring cells and cell re-selection priority per network slice in a system information (SI) message (e.g., a RRC release message). However, this prioritization scheme may not be possible in the intra-frequency scenario (i.e., when the current and neighbouring cells operate in the same frequency range) if the mobile UE has an omnidirectional antenna. This is because the best cell may be causing high interference to the second-best cell if the mobile UE tries to communicate to the second-best cell.

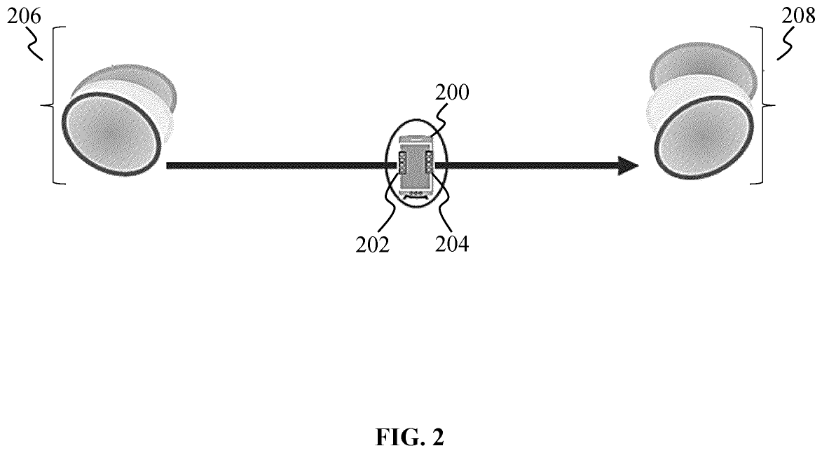

FIG. 2 schematically explains the inter-cell interference issue in the intra-frequency scenario when a mobile UE 200 has an omnidirectional antenna. The omnidirectional antenna is constituted by two antenna elements 202 and 204 arranged on the left and right sides of the mobile UE 200, respectively. It is also assumed that the mobile UE 200 camps on a source cell while being in the coverage of a target cell. A source network node serving the source cell transmits a set 206 of beams to the mobile UE 200, while a target network node serving the target cell transmits a set 208 of beams to the mobile UE 200. In this case, the mobile UE 200 may experience high inter-cell interference when moving to an RRC-connected mode from an RRC-idle or RRC-inactive mode during the conventional cell re-selection procedure. However, this observation does not necessarily apply for an MPUE which has multiple antenna panels with directive antenna elements and beamforming gains.

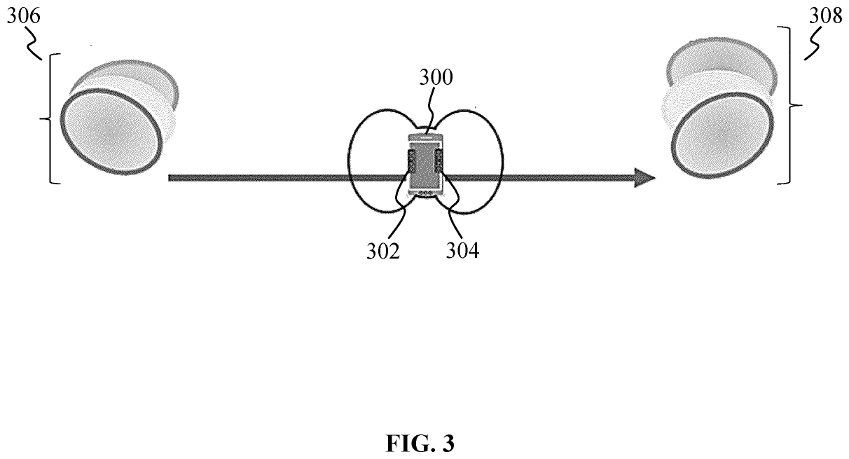

FIG. 3 schematically explains how the inter-cell interference issue may be resolved in the intra-frequency scenario by using a proper antenna panel orientation in a mobile MPUE 300. The mobile MPUE 300 comprises a first antenna panel 302 and a second antenna panel 304. Unlike the antenna elements 202 and 204 in the mobile UE 200, each of the first antenna panel 302 and the second antenna panel 304 is oriented in a different direction, thereby providing a different angular coverage (see two semicircles around the mobile MPUE 300 in FIG. 3). Given the antenna panel orientation shown in FIG. 3, the mobile MPUE 300 may be able to connect to a source cell served by a source network node while being in the coverage area of a target cell served by a target network node. That is, the first antenna panel 302 may receive a set 306 of beams from the source network node, while the second antenna panel 304 may receive a set 308 of beams from the target source, without undergoing strong inter-cell interference during the conventional cell re-selection procedure. This is possible since the inter-cell interference caused by the target cell on the first antenna panel 302 may not be critical since it would be attenuated by the directivity and beamforming gain of the antenna panel 302. In this case, it is possible to effectively extend the area where the mobile MPUE 300 may still camp and connect to the source cell.

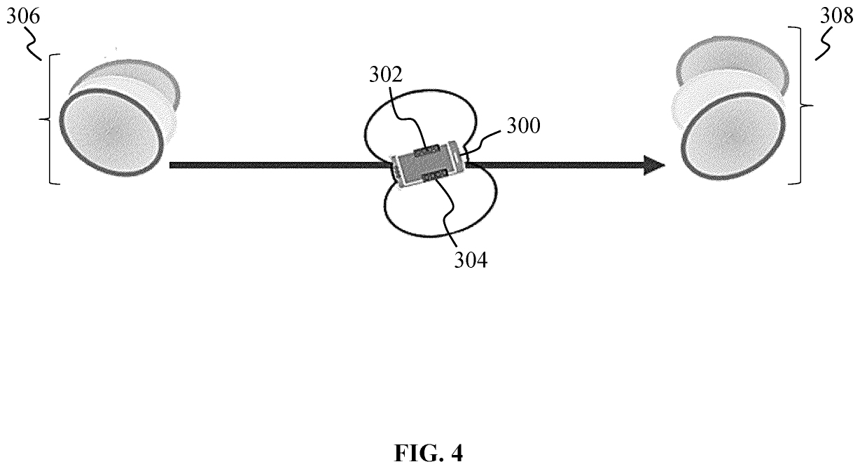

FIG. 4 schematically explains how an improper antenna panel orientation in the mobile MPUE 300 may still cause the inter-cell interference issue in the intra-frequency scenario. More specifically, in the shown example, the sets 306 and 308 of beams from both the source and target network nodes are received and attenuated by the antenna directivity of each of the antenna panel 302 and the antenna panel 304. For this reason, the mobile MPUE 300 may not be able to communicate with the source cell/node while being in the coverage area of the target cell/node (i.e., may have the same issue as the mobile UE 200 in the example shown in FIG. 2), unless the target cell is only few dB stronger than the source cell.

The example embodiments disclosed herein provide a technical solution that allows mitigating or even eliminating the above-sounded drawbacks peculiar to the prior art. In particular, the technical solution disclosed herein involves considering the spatial separation (herein also referred to as the orthogonality) between the cells that support the network slice(s) of a mobile MPUE and other neighbouring cells. The mobile MPUE camps/reselects a cell X that supports its network slices only if the spatial separation between the cell X and other neighbouring cells is deemed to be high enough by the MPUE based on one or more parameters received from a serving network node by using a dedicated or broadcast signalling. By so doing, it is possible to provide the slice-based cell re-selection procedure for the mobile MPUE, which may be effectively (in terms of inter-cell interference suppression) used in the intra-frequency scenario. The spatial separation between the cells may be high enough if the cell X is orthogonal compared with the other neighbouring cells.

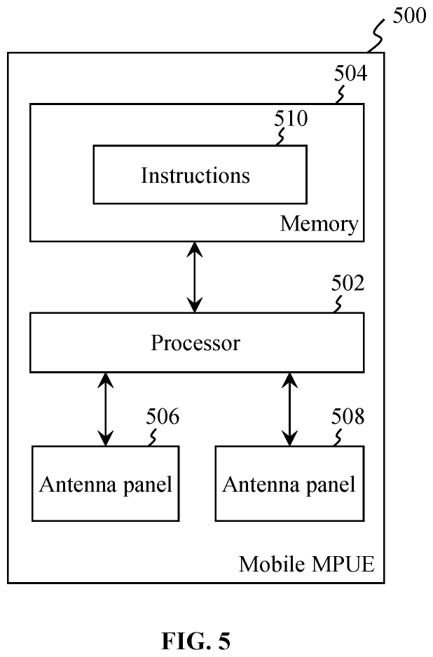

FIG. 5 shows a general block-scheme of a mobile MPUE 500 in accordance with one example embodiment. The mobile MPUE 500 is intended to operate in any of the above-described wireless communication networks that supports the above-mentioned network slicing. Additionally, such a wireless communication network may, for example, operate based on the mmWaves. As shown in FIG. 5, the mobile MPUE 500 comprises a processor 502, a memory 504, a first antenna panel 506, and a second antenna panel 508. The memory 504 stores processor-executable instructions 510 which, when executed by the processor 502, cause the processor 502 to implement the aspects of the present disclosure, as will be described below in more detail. It should be noted that the number, arrangement and interconnection of the constructive elements constituting the mobile MPUE 500, which are shown in FIG. 5, are not intended to be any limitation of the present disclosure, but merely used to provide a general idea of how the constructive elements may be implemented within the mobile MPUE 500. For example, the processor 502 may be replaced with several processors, as well as the memory 504 may be replaced with several removable and/or fixed storage devices, depending on particular applications. Furthermore, there may be more than two antenna panels in the mobile MPUE 500, if required and depending on particular application.

The processor 502 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processor 502 may be implemented as any combination of one or more of the aforesaid. As an example, the processor 502 may be a combination of two or more microprocessors.

The memory 504 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

The processor-executable instructions 510 stored in the memory 504 may be configured as a computer-executable code which causes the processor 502 to perform the aspects of the present disclosure. The computer-executable code for carrying out operations or steps for the aspects of the present disclosure may be written in any combination of one or more programming languages, such as Java, C++, or the like. In some examples, the computer-executable code may be in the form of a high-level language or in a pre-compiled form and be generated by an interpreter (also pre-stored in the memory 504) on the fly.

As for the first antenna panel 506 and the second antenna panel 508, each of them may be implemented by using any conventional antenna manufacturing technology, such, for example, as circuit printing, molding, electroforming, milling, laser cutting, electroplating, etc.

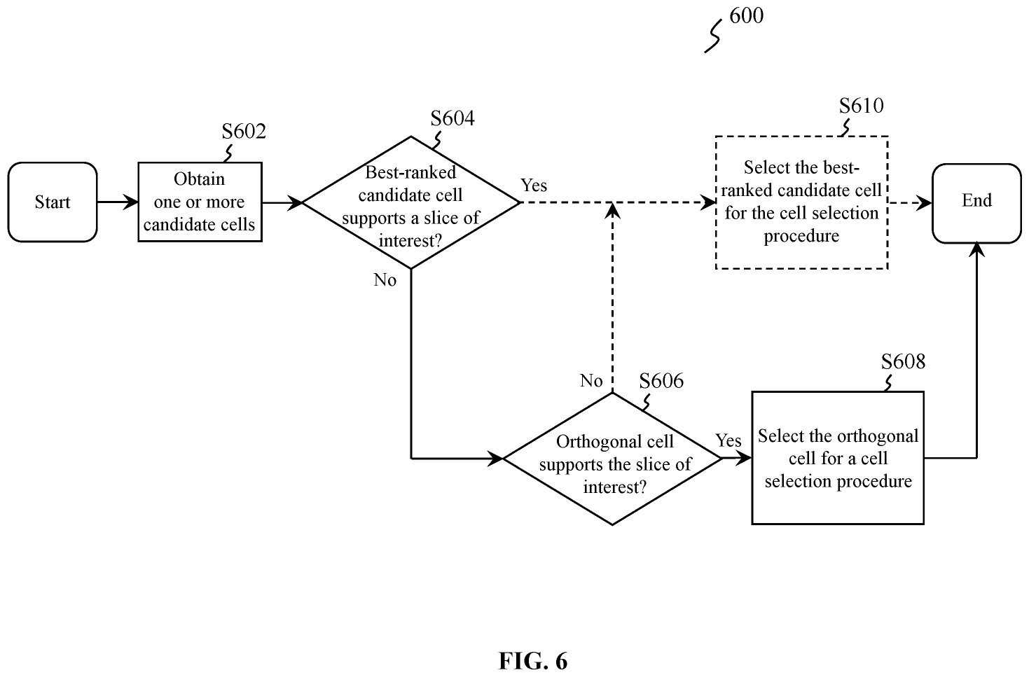

FIG. 6 shows a flowchart of a method 600 for operating the mobile MPUE 500 in accordance with a first example embodiment. The method 600 starts with a step S602, in which the processor 502 obtains one or more candidate cells for a cell re-selection procedure. For example, the processor 502 may obtain a ranked set of two or more candidate cells or may obtain a single candidate cell for the cell re-selection procedure. It is further assumed that the processor 502 obtains the ranked set of candidate cells. It should be noted that the step S602 may be initiated by the processor 502, for example, when the mobile MPUE 500 moves within a selected cell to a border of the selected cell. For this purpose, the mobile MPUE 500 may additionally comprise a Global Positioning System (GPS) sensor configured to provide UE positioning data to the processor 502. As used in the embodiments disclosed herein, the selected cell may represent a cell which the mobile MPUE 500 has previously selected as part of the cell re-selection procedure to camp on. That is, the mobile MPUE 500 will perform the following: 1) monitor common communications channels of the selected cell, such, for example, as a paging channel, to establish a full connection to the selected cell in case of an incoming call or data; and 2) establish the full connection to the selected cell in case the mobile MPUE 500 has some data to transmit to the network. The ranked set of candidate cells may comprise the selected cell itself and one or more neighboring cells, and all candidate cells may be intra-frequency cells. The processor 502 may obtain the ranked set of candidate cells by using reference signals sent from network nodes serving the candidate cells. More specifically, the processor 502 may prepare the ranked set of candidate cells as follows: 1) the processor 502 selects the highest priority frequency based on frequency priorities received from the network node serving the selected cell and measures the cells in a given frequency band; 2) if no cell that meets one or more cell re-selection criteria (e.g., no reference signal has a certain signal value in the mobile MPUE 500) is found, then the processor 502 takes the next highest priority frequency; 3) if the cells that meet the cell re-selection criteria are found, the processor 502 next ranks them in the frequency band, for example, based on the following cell-ranking criteria (defined by 3GPP TS 38.304):

$$Rs = Qmeas , s + Qhyst - Qoffset\_temp ,$$

$$Rn = Qmeas , n - Qoffset - Qoffset\_temp ,$$

where Rs is the cell-ranking criterion for the selected cell, Rn is the cell-ranking criterion for the neighbouring cells, Qmeas is the Reference Signal Received Power (RSRP) measurement quantity used in cell re-selections, and Qhyst/Qoffset/Qoffset_temp are the cell—re-selection parameters defined by the network node serving the selected cell.

Once the ranked set of candidate cells is obtained, the method 600 proceeds to a step S604, in which the processor 502 checks whether a best-ranked candidate cell of the ranked set of candidate cells supports a network slice of interest of the plurality of network slices (i.e., allowed S-NSSAI). For example, the network slice of interest may be designed to support an ULLC service category. The best-ranked candidate cell may be either the selected cell itself or one of the neighboring cells.

If the best-ranked candidate cell does not support the network slice of interest, the method 600 goes on to a step S606, in which the processor 502 determines whether the ranked set of candidate cells comprises any orthogonal cell. The determination may comprise performing one or more communication quality measurements on each candidate cell of the set of candidate cells using the first antenna panel 506 and/or the second antenna panel 508. As used in the embodiments disclosed herein, the orthogonal cell may refer to a candidate cell which, when measured using the first antenna panel 506 and/or the second antenna panel 508, has a communication quality at least a threshold higher than a communication quality of each other candidate cell of the set of candidate cells.

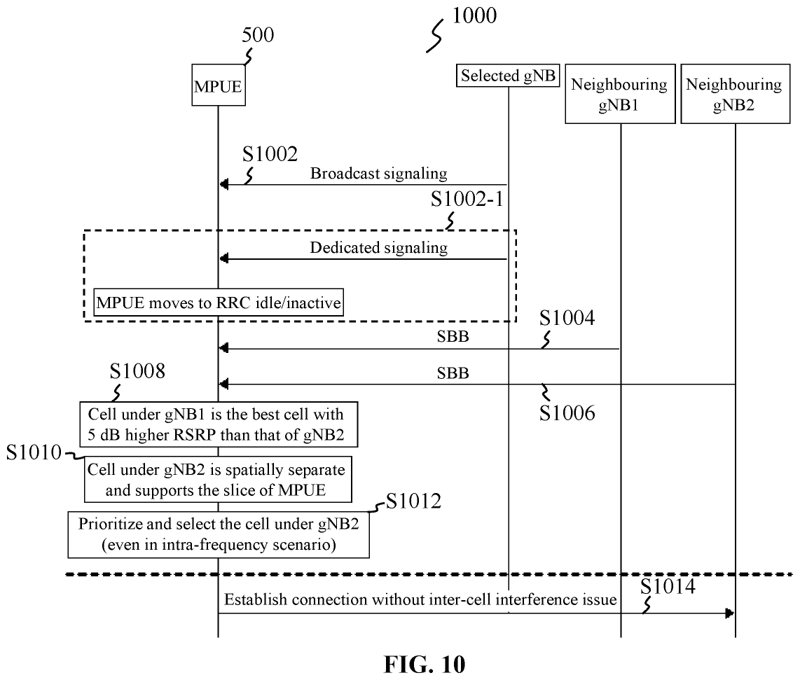

Particularly, the orthogonal cell may refer to a candidate cell which, when measured using a selected antenna panel (e.g., the first antenna panel 506 or the second antenna panel 508), has a communication quality at least a threshold higher than a communication quality of each other candidate cell of the set of candidate cells when measured with the same selected antenna panel. According to an embodiment, the threshold equals to an offset determined based on one or more parameters received from the network node. According to an embodiment, the one or more parameters comprise a slice_orthogonal_threshold received from the network node by the UE. In an embodiment, slice_orthogonal_threshold equals to the threshold used for determining whether or not a candidate cell is orthogonal. In an embodiment, Q_orth discussed below is communicated (e.g., see steps S1002 or S1002-1 of FIG. 10) to the MPUE 500 using an information element slice_orthogonal_threshold.

As for the first antenna panel 506 and the second antenna panel 508, one or both of them may be selected for the communication quality measurements, depending on particular application. For example, when determining the orthogonality of a set of candidate cells, the determination may utilize measurements from multiple antenna panels. For example, let us assume that orthogonality of a first candidate cell needs to be determined. For such determination, the selected antenna panel may be the first antenna panel 506. Thus, the first antenna panel 506 may be used to measure all candidate cells, and these measurement results may be used to determine whether the first candidate cell is orthogonal or not, i.e., whether it is at least the threshold better and/or stronger (in other words, has a higher communication quality) than the other measured candidate cells. To continue the example, the orthogonality of a second candidate cell may also need to be determined. For this determination, the selected antenna panel may be the same or different. Thus, in some examples, the second antenna panel 508 may be used. As above, the same selected antenna panel may be used to measure all the other candidate cells so that the orthogonality of the second candidate cell with the selected antenna panel can be determined. But it is noted that the selected antenna panel may be different for first and second candidate cells.

In a further example, a candidate cell, such as the first candidate cell, may be orthogonal when measured with an antenna panel (e.g., the first antenna panel 506) and with another antenna panel (e.g., the second antenna panel 508). So, it is noted that orthogonality determination may be performed per antenna panel in some instances. Thus, it is noted that an orthogonal cell may be orthogonal on one or more selected antenna panels. If a candidate cell is orthogonal on multiple antenna panels, the UE may select the strongest and/or best cell-antenna panel combination, for example.

So, it may be particularly beneficial to use the same selected antenna panel (sometimes referred to as a serving antenna panel) to measure other candidate cells so that the UE can determine whether or not a particular candidate cell is orthogonal or not with respect to the selected antenna panel. For example, a certain strong candidate cell(s) (e.g., including the best-ranked candidate cell) can be better and/or stronger (e.g., if measured with a different panel, such as the second antenna panel 508) than a candidate orthogonal cell, but when measured with the same selected antenna panel (e.g., the first antenna panel 506), said certain strong candidate cell(s) may not necessarily cause interference to the candidate orthogonal cell, and thus the candidate orthogonal cell may be used with the selected antenna panel (e.g., the first antenna panel 506) without interference exceeding a threshold from said certain strong candidate cell(s). Thus, for example, if the orthogonal cell is found using a certain selected antenna panel, said certain selected antenna panel may be used for communicating in the orthogonal cell. For example, the orthogonal cell can be selected or re-selected for communication if the orthogonal cell also supports the network slice of interest (sometimes referred to as a needed network slice), and the selected antenna panel may be used in the communication. If more than one orthogonal cell is found using, e.g., more than one antenna panel, one of the orthogonal cell(s) that supports the network slice of interest may be selected for communication as discussed herein.

In one embodiment, the processor 502 may select the same antenna panel (e.g., the first antenna panel 506) to perform the communication quality measurements on each candidate cell of the set of candidate cells. In another embodiment, the processor 502 may select both the first antenna panel 506 and the second antenna panel 508 to perform the communication quality measurements on each candidate cell of the set of candidate cells. The latter embodiment means that, for example, the processor 502 may first select the first antenna panel 506 for cell 1 of the set of candidate cells, and the communication quality measurements from the first antenna panel 506 may show that cell 1 is orthogonal compared to the other candidate cells measured with the first antenna panel 506. Then, the processor 502 may select the second antenna panel 508 for cell 1, and the communication quality measurement from the second antenna panel 508 may show that cell 1 is also orthogonal compared to the other candidate cells measured with the second antenna panel 508. Thus, the processor may determine the orthogonal cell(s) among the set of candidate cells by performing such orthogonality test using one or both of the antenna panels 506 and 508 antenna panels. It should be also noted that if the MPUE 500 comprises more than two antenna panels, some or all of them may be used for performing the orthogonality test.

In one embodiment, the processor 502 may select, for each candidate cell of the set of candidate cells, one of the first and second antenna panels 506 and 508 which receives a stronger and/or higher-quality beam from that candidate cell. For example, the stronger and/or higher-quality beam may be determined based on signal measurements, such as RSRP measurements, Signal to Interference plus Noise Ratio (SINR) measurements, and Channel State Information (CSI) measurements. In another embodiment, the processor 502 may select, for each candidate cell of the set of candidate cell, one of the first and second antenna panels 506 and 508 which receives a higher number of beams from that candidate cell. Once one of the first and second antenna panels 506 and 508 is selected by using one of these two embodiments, the selected antenna panel may be further used by the processor 502 to perform the communication quality measurements and, consequently, the orthogonality check.

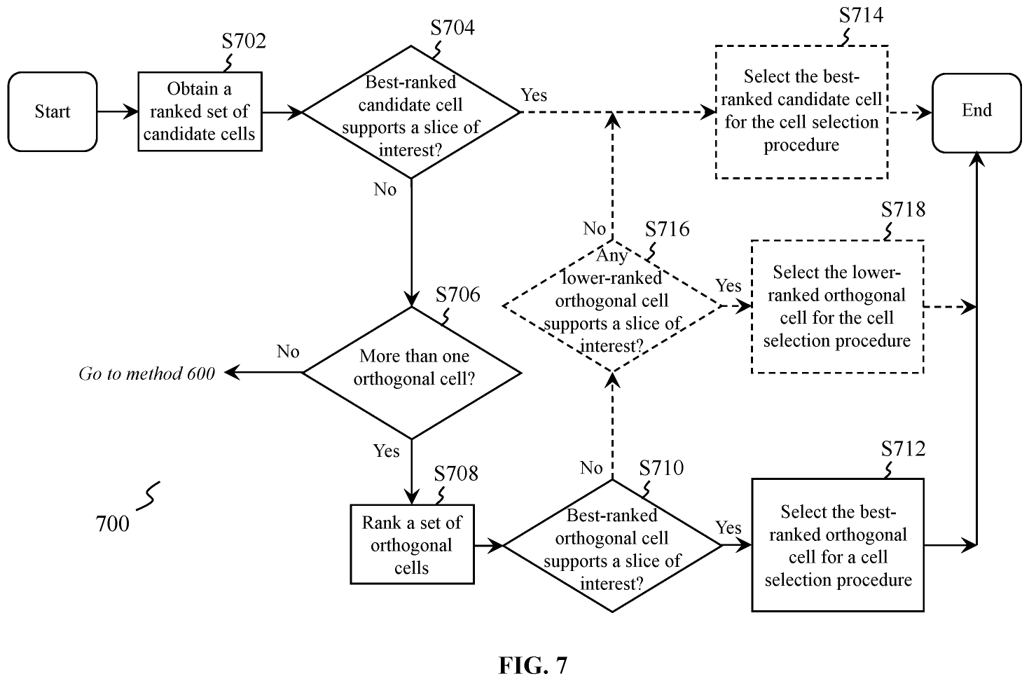

Turning back to FIG. 6, it is further assumed that the processor 502 finds one orthogonal cell among the set of candidate cells (the case of multiple orthogonal cells will be discussed below with reference to FIG. 7), and the orthogonal cell supports the network slice of interest. Then, the method 600 goes on to a step S608, in which the processor 502 selects the orthogonal cell for the cell re-selection procedure.

Going back to the step S604, it should be noted that if the best-ranked candidate cell supports the slice of interest, the method 600 may comprise an optional step S610, in which the processor 502 selects the best-ranked candidate cell for the cell re-selection procedure. If the best-ranked candidate cell is represented by the selected cell, this means that the processor 502 should re-select the (previously) selected cell and re-connect to the network node serving the (previously) selected cell.

Going back to the step S606, it should be noted that if no orthogonal cell is found by the processor 502 or if the orthogonal cell found by the processor 502 does not support the network slice of interest, the method 600 may proceed to the optional step S610.

In one embodiment, the method 600 may comprise an optional step, in which the processor 502 may transmit a UE message to the network node currently serving the mobile MPUE 500, i.e., to the network node serving the selected cell. This transmission may be performed by using at least one of the first and second antenna panels 506 and 508. The UE message may comprise an indication of the network slice of interest and a configuration parameter of the mobile MPUE 500. The configuration parameter may, for example, comprise a number of the antenna panels in the mobile MPUE 500 (i.e., 2 in the example shown in FIG. 5), a number of antenna elements in each of the antenna panels, a gain of each antenna element in each of the antenna panels, a UE hardware specification (e.g., a UE-specific weight, an antenna gain of each of the antenna panels, or any other information affecting the reception capabilities of the mobile MPUE 500 or interference), or any combination of the aforesaid. In response to the UE message, the processor 502 may receive, by using said at least one of the first and second antenna panel 506 and 508, the threshold itself or one or more parameters that allow the processor 502 to determine the threshold by itself. The processor 502 may receive the threshold or the parameter(s) from the network node via a broadcast signaling and/or a dedicated signaling (e.g., a RRC signaling).

FIG. 7 shows a flowchart of a method 700 for operating the mobile MPUE 500 in accordance with a second example embodiment. The method 700 starts with a step S702, in which the processor 502 obtains a ranked set of candidate cells for a cell re-selection procedure. The step S702 may be performed similar to the step S602 of the method 600. Further, similar to the method 600, the method 700 proceeds to a step S704, in which the processor 502 determines whether the best-ranked candidate cell supports a network slice of interest. If the best-ranked candidate cell does not support the network slice of interest, the method goes on to a step S706, in which the processor 502 determines whether the ranked set of candidate cells comprises any orthogonal cell. Again, the step S706 may be performed similar to the step S606 of the method 600. At the same time, unlike the method 600, it is assumed that the processor 502 finds more than one orthogonal cell among the set of candidate cells, e.g., a set of orthogonal cells. If there is only one orthogonal cell among the set of candidate cells, then the method 700 converts to the method 600, as shown in FIG. 7 by using the caption “Go to method 600”. After the set of orthogonal cells is found in the step S706, a next step S708 is initiated, in which the processor 502 ranks the set of orthogonal cells based on the communication qualities measured by using at least one of the first and second antenna panels 506 and 508. The antenna panel(s) may be selected in accordance with one of the embodiments discussed above. After the set of orthogonal cells is ranked, the method 700 proceeds to a step S710, in which the processor 502 determines whether a best-ranked orthogonal cell of the ranked set of orthogonal cells supports the network slice of interest. If the best-ranked orthogonal cell supports the network slice of interest, the method 700 proceeds to a step S712, in which the processor 502 selects the best-ranked orthogonal cell for the cell re-selection procedure.

Going back to the step S704, it should be noted that if the best-ranked candidate cell supports the slice of interest, the method 700 may comprise an optional step S714, in which the processor 502 selects the best-ranked candidate cell for the cell re-selection procedure. If the best-ranked candidate cell is represented by the selected cell, this means that the processor 502 should re-select the (previously) selected cell and re-connect to the network node serving the (previously) selected cell.

Going back to the step S710, it should be noted that if the best-ranked orthogonal cell does not support the network slice of interest, the method 700 may proceed to an optional step 716, in which the processor 502 checks whether the ranked set of orthogonal cells comprises any lower-ranked orthogonal cell that supports the network slice of interest. If any lower-ranked (e.g., second-ranked) orthogonal cell supports the network slice of interest, the method 700 may proceed to an optional step S718, in which the processor 502 selects the next-ranked candidate cell for the cell re-selection procedure. If none of the orthogonal cells in the ranked set of orthogonal cells supports the network slice of interest, the method 700 may proceed to the optional step S714.

It should be also noted that the method 700 may have the same or similar embodiments as the method 600. For example, the method 700 may also comprise an optional step, in which the processor 502 may transmit the UE message to the network node currently serving the mobile MPUE 500 and, in response to the UE message, receive the threshold or the parameter(s) for its determination from the network node a broadcast signaling and/or a dedicated signaling (e.g., together with a RRC release message).

Let us now give some examples of how the threshold may be used in the step S606 of the method 600 or in the step S706 of the method 700 to find the orthogonal cell(s) in the ranked set of candidate cells. In fact, each of the steps S606 and S706 reduces to the following: the processor 502 should determine whether the communication quality of one candidate cell (hereinafter referred to as the cell c) is stronger than any other candidate cell (hereinafter referred to the cell n) by the threshold on the selected panel p for the cell c, where the cell n represents all the candidate cells that are different than the cell c.

In one example, the communication quality of the cell c on the panel p, denoted by L_c_p, is defined as the strongest beam measurement of the cell c on the panel p. Given this, the following comparison should be performed by the processor 502 for each pair of the cell c and cell n:

$$L\_c \_p > L\_n \_p + Threshold , \qquad ( Equation 1 )$$

where L_n_p is the beam measurement of the other cell n on the serving panel p corresponding to the cell c.

If the cell c represents the selected cell, the threshold value is set as

$$Threshold = - Qoffset - Qhyst + Q\_orth ,$$

where Q_orth is the additional orthogonal threshold associated with the slice-based cell re-selection procedure.

If the cell c represents a neighboring cell and the cell n represents the selected cell, the threshold value is set as

$$Threshold = + Qoffset + Qhyst + Q\_orth .$$

If the cell c represents a neighboring cell and the cell n represents another neighboring cell, the threshold value is set as
Threshold=Q_orth.

In another example, the same Equation 1 may be used for the above-mentioned comparison but L_c_p is defined as the average of P strongest beams of the cell c on the serving panel p, instead of the strongest beam.

By so doing, the processor 502 may determine the set S of cells which fulfil Equation 1 and are herein referred to as the orthogonal cells, where S=1, 2, 3 . . . . The cardinality of the set S cannot exceed the number of the antenna panels of the mobile MPUE 500 (i.e., 2 in the example shown in FIG. 2). The processor 502 may decode System Information Block 1 (SIB1) if information about network slice support is not provided by the network node serving the selected cell. It should be noted that if the set S is not empty, the processor 502 does not know the supported S-NSSAIs of the cells in the set, then the processor 502 may decode the SIB1 of these cells to obtain S-NSSAI support information. If any of the cells in the set S supports all the allowed S-NSSAIs of the mobile MPUE 500, the processor 502 selects to that cell. If multiple cells in the set S support all the allowed S-NSSAIs of the mobile MPUE 500, then the processor 502 selects that cell in the set S which has the highest signal measurement on its serving antenna panel. At the same time, if the set S is empty (i.e., the ranked set of candidate cells has no candidate cell that fulfills Equation 1), the processor 502 may proceed to the optional step S610 of the method 600 or to the optional step S714 of the method 700 and select the best-ranked (e.g., in terms of Rn and Rs) candidate cell for the cell re-selection procedure.

It should be also noted that Equation 1 is a quite complex operation. Assuming the mobile MPUE 500 observes in total X cells, including the neighbouring cells and the selected cell, and has Y antenna panels, the number of evaluations the processor 502 has to do is X choose 2 times Y, namely:

$$( \begin{matrix}X \\ 2\end{matrix} ) \cdot Y .$$

For example, given 20 observable cells and 4 antenna panels, there will be 760 evaluations. In this case, the processor 502 may apply further optimizations to decrease the complexity of this analysis. The processor 502 may compare Z best cells (that it knows that supports the allowed S-NSSAIs of the mobile MPUE 500) on each antenna panel with all other cells, namely:

$$( \begin{matrix}Z \\ 2\end{matrix} ) \cdot Y$$

For example, given Z set to 3 and 4 antenna panels in the mobile MPUE 500, the processor 502 should perform 12 evaluations.

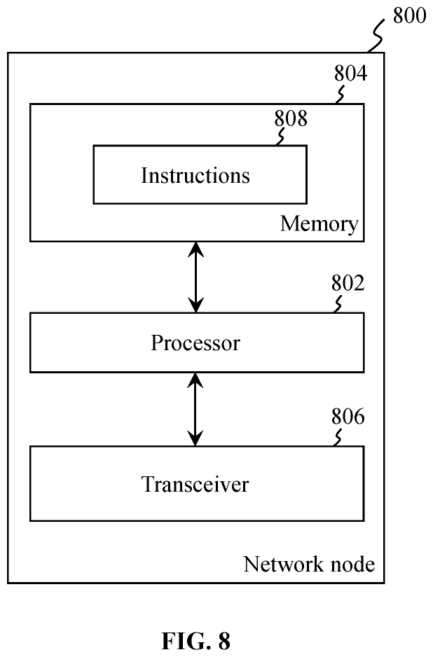

FIG. 8 shows a general block-scheme of a network node 800 in accordance with one example embodiment. The network node 800 is intended to communicate with the mobile MPUE 500 in any of the above-described wireless communication networks that supports the above-mentioned network slicing. Additionally, such a wireless communication network may, for example, operate based on the mmWaves. As shown in FIG. 8, the network node 800 comprises a processor 802, a memory 804, and a transceiver 806. The memory 804 stores processor-executable instructions 808 which, when executed by the processor 802, cause the processor 802 to implement the aspects of the present disclosure, as will be described below in more detail. It should be noted that the number, arrangement and interconnection of the constructive elements constituting the network node 800, which are shown in FIG. 8, are not intended to be any limitation of the present disclosure, but merely used to provide a general idea of how the constructive elements may be implemented within the network node 800. For example, the processor 802 may be replaced with several processors, as well as the memory 804 may be replaced with several removable and/or fixed storage devices, depending on particular applications. In general, the processor 802, the memory 804 and the processor-executable instructions 808 may be implemented in the same or similar manner as the processor 502, the memory 504 and the processor-executable instructions 510, respectively, in the mobile MPUE 500. Furthermore, in some embodiments, the transceiver 806 may be implemented as two individual devices, with one for a receiving operation and another for a transmitting operation. Irrespective of its implementation, the transceiver 806 is intended to be capable of performing different operations required to perform the data reception and transmission, such, for example, as signal modulation/demodulation, encoding/decoding, etc.

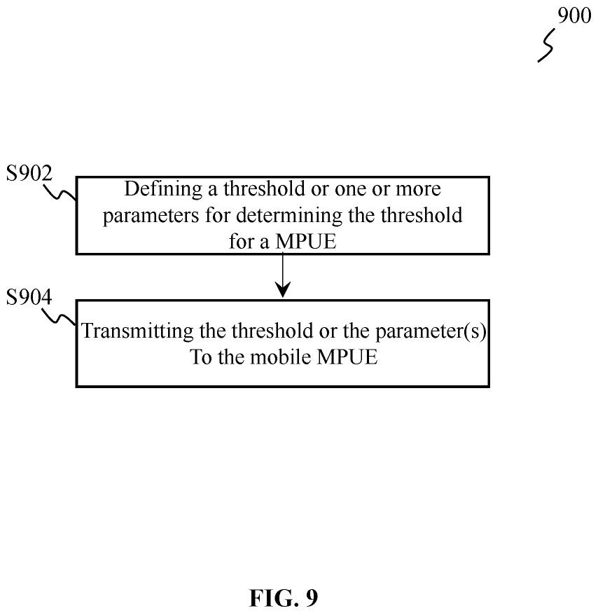

FIG. 9 shows a flowchart of a method 900 for operating the network node 800 in accordance with one example embodiment. The method 900 starts with a step S902, in which the processor 802 defines a threshold or one or more parameters for determining the threshold for the MPUE 500. As noted earlier, the threshold is to be used by the MPUE to find the orthogonal cell(s) in the ranked set of candidate cells by performing the above-mentioned orthogonality test. After the threshold or the parameter(s) is (are) defined, the method 900 proceeds to a step S904, in which the processor 802 transmits the threshold or the parameter(s) to the MPUE 500, e.g., by using the broadcast signaling and/or the dedicated signaling.

In one embodiment, the processor 502 may define the threshold or the parameter(s) based on the UE message from the MPUE 500. In another embodiment, the processor 502 may define the threshold or the parameter(s) based on some other information available to the network node 800 (e.g., network slice usage statics, etc.), and broadcast them to all MPUEs in the wireless communication system. Thus, the processor 502 may use either the UE-specific or common approach for performing the step S902.

FIG. 10 shows an interaction diagram 1000 that explains the interaction between the mobile MPUE 500 and the network nodes serving neighbouring and selected (camped-on) cells in accordance with one example embodiment. The network node serving the selected cell may be implemented as the network node 800. In the interaction diagram 1000, it is assumed that the network nodes are all implemented as gNBs, meaning that the interaction occurs in a 5G wireless communication network. It is also assumed that the 5G wireless communication network supports the above-mentioned network slicing, and the MPUE 500 is granted the allowed S-NSSAI of network slice 2 and has an inactive PDU session with network slice 2 for the RRC-idle/inactive mode. The interaction diagram 1000 may start either with a step S1002 or a step S1002-1. The step S1002 implies that the mobile MPUE 500 reads SIBs from the gNB serving the selected (or camped-on) cell (also referred to as the selected gNB for short). In particular, the mobile MPUE 500 may read the threshold or the parameter(s) for its determination from the SIB. The step S1002-1 implies that the selected gNB causes the mobile MPUE 500 to move from the RRC-connected mode to the RRC-inactive/idle mode by sending an RRC release message to the mobile MPUE 500. The RRC release message may comprise the threshold or the parameter(s) for its determination, and the mobile MPUE 500 may read it from the RRC release message in the step S1002-1. It should be noted the RRC release message is one example of UE-specific dedicated signaling. If required and depending on particular applications, any other types of the UE-specific dedicated signaling may be also used to inform the mobile MPUE 500 about the threshold value. The interaction diagram 1000 further proceeds to steps S1004 and S1006, in which the mobile MPUE 500 measures the communication qualities of cells 1 and 2 which are controlled by gNB1 and gNB2, respectively, by using Synchronization Signal Blocks (SBBs) transmitted by gNB1 and gNB2. Cell 1 of gNB 1 is assumed to support network slice 1, while cell 2 of gNB2 is assumed to support network slice 2. The mobile MPUE 500 may be aware of the network slice support of cells 1 and 2 through the broadcast signaling or previous dedicated signaling before it went to the RRC-idle/inactive mode. The steps S1004 and S1006 may be performed in parallel or in sequence. Then, the interaction diagram 1000 goes on to a step S1008, in which the mobile MPUE 500 evaluates cell re-selection criteria. For example, the mobile MPUE 500 may determine the following:
1) both cells 1 and 2 are above a cell re-selection criterion, as defined, for example, in 3GPP TS 38.304;
2) rankings of both cells 1 and 2 are higher than the ranking of the selected cell (served by selected gNB) (e.g., the ranking of cell 1 is higher than the ranking of cell 2, i.e., Rn1>Rn2, where both the rankings are evaluated using cell quality measurements, as defined in the 3GPP standard—e.g., there is a 5 dB difference between their rankings).

After that, the interaction diagram 1000 proceeds to a step S1010, in which, as cell 1 does not supports network slice 2 of the mobile MPUE 500, the mobile MPUE 500 evaluates the spatial separation or orthogonality between two cells 1 and 2. It should be noted that the mobile MPUE 500 may be pre-configured to do this by the selected gNB, or the mobile MPUE 500 may be required to do this by the standardization applied to the 5G wireless communication network, or the mobile MPUE 500 may decide that target cell 1 and 2 are orthogonal by itself, as discussed above with reference to the method 600 and the method 700. It is assumed that cell 2 is orthogonal (e.g., fulfils Equation 1 above), and since it supports the allowed network slice of the mobile MPUE 500, the mobile MPUE 500 prioritizes gNB2 over gNB1 for the cell re-selection procedure. Subsequently, when the mobile MPUE 500 establishes connection with gNB2 in a next step S1014 of the interaction diagram 1000, it may communicate without any interference problem even in the intra-frequency scenario.

It should be noted that each step or operation of the methods 600, 700, 900 and the interaction diagram 1000, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processor 502 and the processor 802, respectively. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the example embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1-23. (canceled)

24. A mobile user equipment (UE) for a wireless communication network supporting a plurality of network slices, wherein the mobile UE comprises:
at least two antenna panels each having a different angular coverage;
a processor coupled to the at least two antenna panels; and
a memory coupled to the processor and storing processor-executable instructions,
wherein the processor is configured, when executing the processor-executable instructions, to:
obtain at least one candidate cell for a cell re-selection procedure, each of the at least one candidate cell having a rank;
determine whether a best-ranked candidate cell of the at least one candidate cell supports a network slice of interest of the plurality of network slices:
if the best-ranked candidate cell does not support the network slice of interest, determine whether the at least one candidate cell comprises at least one orthogonal cell, by performing one or more communication quality measurements on each of the at least one candidate cell using one or more of the at least two antenna panels;
if the at least one candidate cell comprises the at least one orthogonal cell, determine whether the at least one orthogonal cell comprises an orthogonal cell that supports the network slice of interest; and
if the at least one at least one orthogonal cell comprises the orthogonal cell that supports the network slice of interest, select the orthogonal cell for the cell re-selection procedure.

25. The mobile UE of claim 24, wherein the at least one candidate cell comprises a set of candidate cells, and wherein the processor is configured to determine that a candidate cell of the set of candidate cell is an orthogonal cell if the candidate cell, when measured using said one or more of the at least two antenna panels, has a communication quality at least a threshold higher than a communication quality of each other candidate cell of the set of candidate cells.

26. The mobile UE of claim 25, wherein the processor is further configured to:
generate a UE message comprising a configuration parameter of the mobile UE and an indication of the network slice of interest;
by using one or more of the at least two antenna panels, transmit the UE message to a network node currently serving the mobile UE in the wireless communication network; and
by using said one or more of the at least two antenna panels, receive the threshold or at least one parameter for determining the threshold from the network node.

27. The mobile UE of claim 26, wherein the configuration parameter comprises least one of:
a number of the at least two antenna panels,
a number of antenna elements in each of the at least two antenna panels,
a gain of each antenna element in each of the at least two antenna panels, and
a hardware specification of the mobile UE.

28. The mobile UE of claim 26, wherein the processor is configured to receive the threshold or the at least one parameter for determining the threshold via at least one of a broadcast signaling and a dedicated signaling from the network node.

29. The mobile UE of claim 24, wherein the processor is configured to select the same antenna panel of the at least two antenna panels to perform the communication quality measurements on each candidate cell of the set of candidate cells.

30. The mobile UE of claim 24, wherein the processor is configured to select two or more antenna panels of the at least two antenna panels to perform the communication quality measurements on each candidate cell of the set of candidate cells.

31. The mobile UE of claim 24, wherein the processor is configured to:
select, from the at least two antenna panels, an antenna panel which receives a stronger and/or higher-quality beam from the candidate cell; and
perform the communication quality measurements on the candidate cell using the selected antenna panel.

32. The mobile UE of claim 24, wherein the processor is configured to:
select, from the at least two antenna panels, an antenna panel which receives a higher number of beams from the candidate cell; and
perform the communication quality measurements on the candidate cell using the selected antenna panel.

33. The mobile UE of claim 24, wherein the processor is further configured, if the best-ranked candidate cell supports the network slice of interest, to select the best-ranked candidate cell for the cell re-selection procedure.

34. The mobile UE of claim 24, wherein the processor is further configured, if the at least one candidate cell does not comprise the at least one orthogonal cell, to select the best-ranked candidate cell for the cell re-selection procedure.

35. The mobile UE of claim 24, wherein the processor is further configured, if the at least one orthogonal cell comprises a set of orthogonal cells, to:
measure a communication quality of each orthogonal cell of the set of orthogonal cells by using said one or more of the at least two antenna panels;
rank the set of orthogonal cells based on the communication qualities;
determine whether a best-ranked orthogonal cell of the ranked set of orthogonal cells supports the network slice of interest;
if the best-ranked orthogonal cell of the ranked set of orthogonal cells supports the network slice of interest, select the best-ranked orthogonal cell for the cell re-selection procedure.

36. The mobile UE of claim 35, wherein the processor is further configured, if the best-ranked orthogonal cell does not support the network slice of interest, to:
determine whether the ranked set of orthogonal cells comprises a lower-ranked orthogonal cell that supports the network slice of interest; and
if the ranked set of orthogonal cells comprises the lower-ranked orthogonal cell that supports the network slice of interest, select the lower-ranked orthogonal cell for the cell re-selection procedure.

37. The mobile UE of claim 36, wherein the processor is further configured, if the ranked set of orthogonal cells does not comprise the lower-ranked orthogonal cell that supports the network slice of interest, to select the best-ranked candidate cell for the cell re-selection procedure.

38. The mobile UE of claim 24, wherein the at least one candidate cell comprises a set of intra-frequency cells.

39. A network node in a wireless communication network supporting a plurality of network slices, wherein the network node comprises:
a transceiver;
a processor coupled to the transceiver; and
a memory coupled to the processor and storing processor-executable instructions, wherein the processor is configured, when executing the processor-executable instructions, to:
define a threshold or at least one parameter for determining the threshold for a multi-panel mobile UE in the wireless communication network, wherein the threshold is to be used by the mobile UE to find at least one orthogonal cell in a set of candidate cells used for a cell re-selection procedure, and wherein a candidate cell of the set of candidate cells is an orthogonal cell if the candidate cell, when measured using one or more antenna panels of the mobile UE, has a communication quality at least the threshold higher than a communication quality of each other candidate cell of the set of candidate cells; and
by using the transceiver, transmit the threshold or the at least one parameter for determining the threshold to the mobile UE.

40. The network node of claim 39, wherein the processor is configured to receive, by using the transceiver, a UE message from the mobile UE, the UE message comprising a configuration parameter of the mobile UE and an indication of a network of interest among the plurality of network slices, and wherein the processor is configured to define the threshold or the at least one parameter for determining the threshold based on the UE message.

41. The network node of claim 40, wherein the configuration parameter of the mobile UE comprises at least one of:
a number of the antenna panels in the mobile UE,
a number of antenna elements in each of the antenna panels,
a gain of each antenna element in each of the antenna panels, and
a hardware specification of the mobile UE.

42. The network node of claim 39, wherein the processor is configured to transmit the threshold or the at least one parameter for determining the threshold to the mobile UE via at least one of a broadcast signaling and a dedicated signaling.

43. A method for operating a mobile user equipment (UE) in a wireless communication network supporting a plurality of network slices, wherein the mobile UE comprises at least two antenna panels each having a different angular coverage, and wherein the method comprises:
obtaining at least one candidate cell for a cell re-selection procedure, each of the at least one candidate cell having a rank;
determining whether a best-ranked candidate cell of the at least one candidate cell supports a network slice of interest of the plurality of network slices;
if the best-ranked candidate cell does not support the network slice of interest, determining whether the at least one candidate cell comprises at least one orthogonal cell by performing one or more communication quality measurements on each of the at least one candidate cell using one or more of the at least two antenna panels;
if the at least one candidate cell comprises the at least one orthogonal cell, determining whether the at least one orthogonal cell comprises an orthogonal cell that supports the network slice of interest; and
if the at least one orthogonal cell comprises the orthogonal cell that supports the network slice of interest, selecting the orthogonal cell for the cell re-selection procedure.
